(19) United States
(12) Patent Application Publication
(10) Pub. No.: US 2012/0226922 A1
(43) Pub. Date: Sep. 6, 2012

(54) CAPPING DATA CENTER POWER CONSUMPTION

(76) Inventors: Zhikui Wang, Fremont, CA (US); Cullen E. Bash, Los Gatos, CA (US); Chandrakant Patel, Fremont, CA (US); Niraj Tolia, Mountain View, CA (US)

(21) Appl. No.: 13/040,748

(22) Filed: Mar. 4, 2011

(51) Int. Cl. G06F 1/26

(52) U.S. Cl. 713/320

(57) ABSTRACT

Example systems, methods and articles of manufacture to cap data center power consumption are disclosed. A disclosed example system includes a group power capper to allocate a fraction of power for a data center to a portion of the data center, a domain power capper to allocate hosted applications to a server of the portion of the data center to comply with the allocated portion of the power, and a local power capper to control a first state of the server and a second state of a cooling actuator associated with the portion of the data center to comply with the allocated portion of the power.

### BACKGROUND

Power consumption is a factor in the design and operation of enterprise servers and data centers.

### BRIEF DESCRIPTION OF THE DRAWINGS

FIG. 1 is a schematic illustration of an example data center having a layered power capping system structured in accordance with the teachings of this disclosure.

FIG. 2 illustrates an example manner of implementing any of the example group power cappers (GPCs) of FIG. 1.

FIG. 3 illustrates an example process that may be implemented using machine-accessible instructions, which may be executed by, for example, one or more processors, to implement any of the example GPCs of FIGS. 1 and 2.

FIG. 4 illustrates an example manner of implementing any of the example domain power cappers (DPCs) of FIG. 1.

FIG. 5 illustrates an example process that may be implemented using machine-accessible instructions, which may be executed by, for example, one or more processors, to implement any of the example DPCs of FIGS. 1 and 4.

FIG. 6 illustrates an example manner of implementing any of the example local power cappers (LPCs) of FIG. 1.

FIG. 7 illustrates an example process that may be implemented using machine-accessible instructions, which may be executed by, for example, one or more processors, to implement any of the example LPCs of FIGS. 1 and 6.

FIG. 8 is a schematic illustration of an example processor platform that may be used and/or programmed to execute the example machine-accessible instructions of FIGS. 3, 5 and 7 to cap data center power consumption.

### DETAILED DESCRIPTION

Server and server cluster power management solutions often use “compute actuators” such as P-state control, workload migration, load-balancing, and turning servers on and off to manage power consumption. Additionally or alternatively, power management solutions may migrate workloads between data centers to exploit differences in electricity pricing or operational efficiency. Traditional power management solutions seek to reduce server power consumption while reducing the impact on workload performance. However, server power consumption is only one component of the total power consumed by a data center. Another significant contributor is the power consumed by cooling equipment such as fans, computer room air conditioners (CRACs), chillers, and/or cooling towers. Unfortunately, traditional power management solutions do not consider the allocation of power consumption to computing and cooling resources.

Additionally, there is increasing interest in smart electrical grids and their impact on data centers. Driven by the goals of creating a more reliable and efficient electric grid and the need to reduce carbon emissions, a number of international government organizations, including the U.S. Department of Energy, are advocating the notion of smart electrical grids. The goal of smart electrical grids is to transition today's centralized electrical grids to electrical grids with less centralization and better responsiveness. A component of these initiatives that may affect data centers, including large warehouse-style data centers hosting cloud-based application servers, is the advanced metering infrastructure (AMI), which allows energy to be priced on what it costs in near real-time. This is in sharp contrast to the near-flat rate pricing currently in use. In particular, electricity prices can become dictated by mechanisms such as time-of use pricing, critical-peak pricing, real-time pricing and/or peak-time rebates. With time-of-use pricing, utilities set different on and off-peak rates based on time-of-year, day-of-week, and/or time-of-day. With critical-peak pricing, peak rates for large customers vary with conditions such as forecasted temperature and/or forecasted load. For real-time pricing, energy prices are set in almost real-time depending on market price(s). With peak-time rebates, customers agree to a baseline price and receive a significant rebate (e.g., 40-200 times normal prices) for reducing usage below their baseline.

To address the challenge with managing server power consumption rather than combined server and cooling power consumption, example layered power capping systems are disclosed herein. The example layered power capping systems also facilitate cost savings by taking advantage of the pricing structures in smart electrical grids. The disclosed example layered power capping systems can be used to enforce a global power cap on a data center by limiting the total power consumption (server and cooling) of a data center (or a group of data centers) to a given power budget. The power budget may be selected, controlled and/or adjusted based on a number of parameters such as, but not limited to, cost, capacity, thermal limitations, performance loss, etc. Additionally, power budgets can be varied over time in response to changes in the price of electricity, or to incentive payments designed to induce lower electricity use at times of high wholesale market prices and/or when system reliability is jeopardized.

As used herein, resource demand of a workload is represented by the computing capacity requirement of the application(s) to meet performance objectives and/or service level objectives such as throughput and response time targets. Active workload management (e.g., admission control, load balancing, and workload consolidation through virtual machine migration, etc.) can be used to vary server workload. Additionally, power consumption limits affect computing capacity because dynamic tuning of server power states affects computing capacity. Cooling demand of computing systems is defined by the cooling capacity required to meet the thermal requirement of the computing systems such as a temperature threshold. Power management can be formulated as an optimization problem that coordinates power resources, cooling supplies, and power/cooling demand.

The example layered power capping systems disclosed herein enforce the global and local power budgets in a data center through multiple actuators including, but not limit to, workload migration/consolidation, server power status tuning such as dynamic voltage/frequency tuning, dynamic frequency throttling, and/or server on/off/sleeping, while respecting other objectives and constraints such as minimizing the total power consumption, minimizing the application performance loss and/or meeting the thermal requirements of the servers. As used herein, the term “server” refers to a computing server, a blade server, a networking switch and/or a storage system. The term “cooling actuator” refers to a device, an apparatus and/or a piece of equipment (e.g., a server fan, a vent tile, a computer room air conditioner (CRAC), a chiller, a pump, a cooling tower, etc.) that provides a cooling resource. Example “cooling resources” include, but are not limited to, cooled air, chilled water, etc.

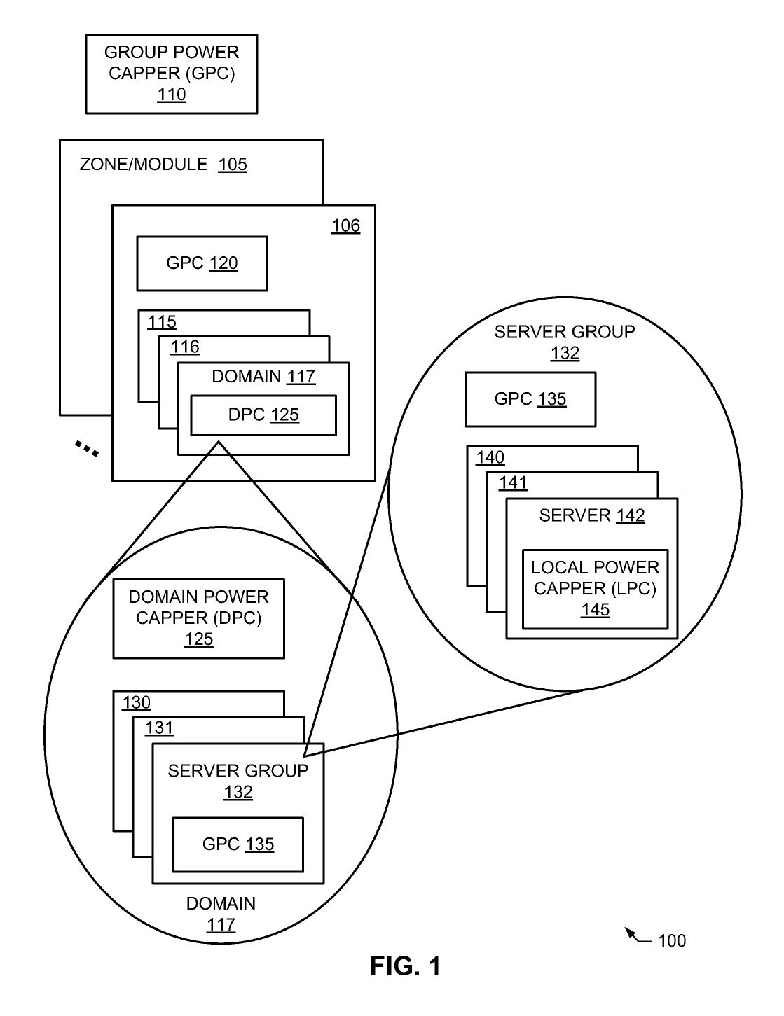

FIG. 1 illustrates an example data center 100 including a plurality of zones and/or modules 105 and 106. Example zones and/or modules 105 and 106 include, but are not limited to, a rack of servers, a row of racks of servers, a cold aisle, racks of servers that share a power distribution unit, and/or racks of servers that share an uninterruptable power supply. In other examples, the zones and/or modules 105 and 106 represent different data centers located at a same or different geographic location.

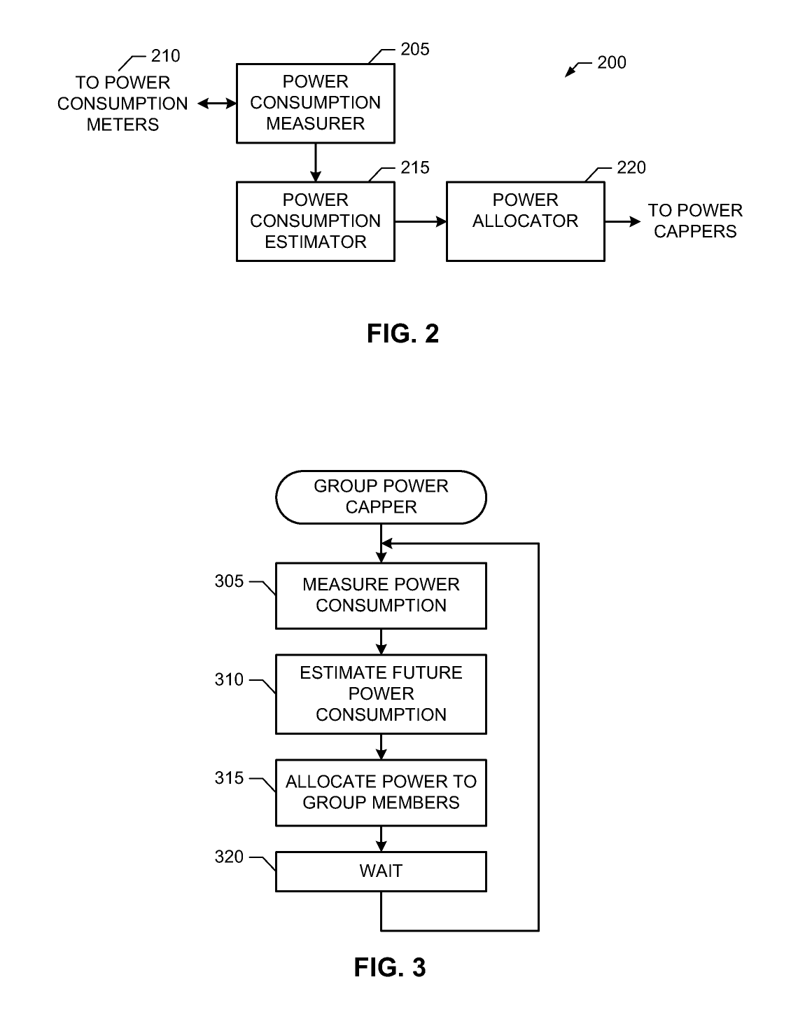

To allocate power, the example data center 100 of FIG. 1 includes a group power capper (GPC) 110. The example GPC 110 of FIG. 1 allocates percentages or fractions of a target, allowed, maximum and/or total power consumption to its group members, e.g., the zones and/or modules 105 and 106. The example GPC 110 of FIG. 1 allocates power to the zones and/or modules 105 and 106 based on their estimated, projected and/or measured demand, and the estimated, projected and/or measured power consumption of the cooling actuators of the zones and/or modules 105 and 106 using any number and/or type(s) of method(s), algorithm(s) and/or logic such as optimization, power consumption models and/or feedback control. When, for example, the zones and/or modules 105,106 represent different data centers, the example GPC 110 of FIG. 1 may allocate power to the data centers 105 and 106 based on time-of-day or the cost(s) of electricity at each of the data centers 105 and 106. For example, the GPC 110 may allocate more power to the data center 105 and 106 having the lowest electricity cost, power generated from a renewable resource such as solar and/or wind, and/or the lowest ambient temperature. An example manner of the implementing the example GPC 110 is described below in connection with FIG. 2.

Each of the example zones and/or modules 105 and 106 of FIG. 1 includes any number and/or type(s) of domains 115-117. As used herein, a domain is a set of servers or a set of server groups 130-132 belonging to an admission control group, a load balancing group, and/or a workload migration group. In other words, a domain is a set of servers for which the allocation and/or migration of applications such as virtual machines within the servers can be used to control the power consumption of the domain to comply with a prescribed power budget. A domain may include servers at different locations having different electricity cost, different amounts of power generated from a renewable resource and/or different ambient temperatures.

To allocate power, each of the example zones and/or modules 105 and 106 of FIG. 1 includes a respective GPC 120. The example GPC 120 of FIG. 1 allocates percentages or fractions of the power consumption allocated to its associated zone and/or module 105 and 106 to its member domains 115-117. The example GPC 120 of FIG. 1 allocates power to the domains 115-117 based on their estimated, projected and/or measured demand, and the estimated, projected and/or measured power consumption of the cooling actuators associated with the domains 115-117 using any number and/or type(s) of method(s), algorithm(s) and/or logic such as optimization, power consumption models and/or feedback control. An example manner of the implementing the example GPC 110 is described below in connection with FIG. 2.

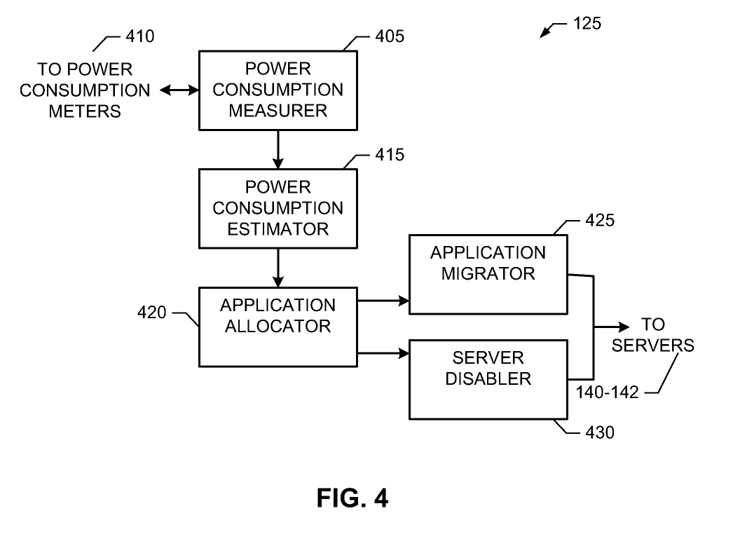

To control workload, each of the example domains 115-117 of FIG. 1 includes a respective domain power capper (DPC) 125. The example DPC 125 of FIG. 1 allocates applications among its servers and/or server groups 130-132 to comply with the power consumption allocated to its respective domain 117 by the GPC 120. The example DPC 125 uses admission control, workload migration, workload consolidation and/or load balancing to comply with its allocated power consumption using any number and/or type(s) of method(s), algorithm(s) and/or logic such as optimization, power consumption models and/or feedback control. The example DPC 125 may, additionally or alternatively, turn servers and/or server groups 130-132 on and/or off. Example algorithms that may be used to assign applications to servers include, but are not limited to, simulated annealing and/or genetic hill climbing. The DPC 125 can estimate power consumption using a server power model (see below) and the power consumption of cooling actuators can be estimated using heat-load, thermal requirements and cooling capacity models (see below). To reduce over consolidation of workload, the DPC 125 may consider the power budgets of the servers and/or server groups 130-132 belonging to the domain 117. An example manner of the implementing the example DPC 120 of FIG. 1 is described below in connection with FIG. 4.

Each of the example server groups 130-132 of FIG. 1 includes any number and/or type(s) of servers 140-142. To allocate power, each of the example server groups 130-132 of FIG. 1 includes a respective GPC 135. The example GPC 135 of FIG. 1 allocates percentages or fractions of the power consumption allocated to its server group 132 to its member servers 140-142. The example GPC 135 of FIG. 1 allocates power to the servers 140-142 based on their estimated, projected and/or measured demand, and the estimated, projected and/or measured power consumption of the cooling actuators associated with the servers 140-142 using any number and/or type(s) of method(s), algorithm(s) and/or logic such as optimization, power consumption models and/or feedback control. An example manner of the implementing the example GPC 135 is described below in connection with FIG. 2.

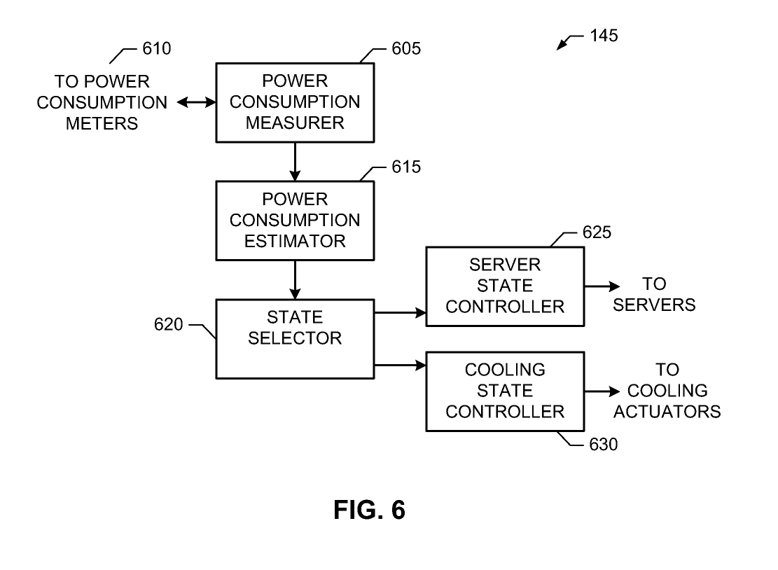

To control power, each of the example servers 140-142 of FIG. 1 includes a respective local power capper (LPC) 145. The example LPC 145 of FIG. 1 maintains, controls, caps and/or limits the power consumption of its server 142 to comply with and/or be less than the power allocated by the GPC 135. The example LPC 145 uses, for example, feedback control such as a proportional integral derivative (PID) controller and/or a model predictive controller to select and/or control the state of its server 142 (power status, sleep state, supply voltage tuning, clock frequency, etc.) and/or to select and/or control the state of cooling actuators (e.g., fans, etc.) associated with the server 142. An example manner of implementing the example LPC 145 is described below in connection with FIG. 6.

The example GPCs 110, 120 and 135, the example DPC 125 and the example LPC 145 of FIG. 1 work from interval to interval to automatically adjust and/or respond to changes in power allocations and/or power demands. In other words, the GPCs 110, 120 and 135, the example DPC 125 and the example LPC 145 use estimated and/or measured power consumption from one or more time intervals to make power allocation and/or power control decisions for subsequent time interval(s). In the illustrated example of FIG. 1, the GPCs 110, 120 and 135 operate using longer time intervals than the DPC 125, and the DPC 125 operates using a longer time interval than the LPC 145.

The example GPCs 110, 120 and 135, the example DPC 125 and the example LPC 145 of FIG. 1 estimate computing resource power consumption using real-time measurements, historical measurements and/or power consumption models. For example, server power consumption can be estimated from workload data and/or performance requirements using server power models. An example server power model can be expressed as:

POWₛ=Powerₛₑᵣᵥₑᵣ(Workload,PowerStatus,CoolingStatus) EQN (1)

The example server power model of EQN (1) includes: (A) workload demand, which can be represented by the CPU/Memory/Disk IO/Networking Bandwidth usage; (B) power status of the server, which can be tuned dynamically by the LPC 145; and (C) power consumption of cooling actuators, which is a function of the their status, e.g., the fan speed, and may be adapted to maintain a suitable thermal condition of the server.

Cooling actuator power consumption can be estimated using cooling actuator power models, cooling capacity models and/or thermal requirements. An example server thermal model, which represents the thermal condition of a server (e.g., ambient temperature) can be expressed as:

Thermₛ=ThermalConditionₛₑᵣᵥₑᵣ(Workload,PowerStatus,CoolingStatus,ThermalStatus) EQN (2)

In addition to workload, power status, and cooling status, thermal conditions may be affected by the thermal status of the server such as the inlet cooling air temperature and the cool air flow rate, which can be dynamically tuned by the internal server cooling controllers and external data center cooling controllers. The example server thermal model of EQN (2) can also be utilized to estimate the cooling demand, or cooling capacity needed by a server to meet the thermal constraints of the server given its workload and power status.

In some examples, chilled water from a chiller can be shared by multiple CRACs, cool air flow from one CRAC unit can be sent to multiple contained/un-contained cold aisles, cool air from the perforated floor tiles can be shared by multiple racks of servers, air flows drawn by the fans can be shared by multiple blades in a blade enclosure, air flows drawn by the fans can be shared by multiple components/zones in a single rack-mounted server, etc. An example cooling capacity model, which represents the cooling ability provided by the cooling actuators shared by multiple servers, can be expressed as:

CoolingCapacity=SharingCoolingCapacity(CoolingStatus,ThermalStatus) EQN (3)

The power consumption of a cooling actuator such as a CRAC, a chiller, and/or a cooling tower depends on the thermal status of the cooling resources provided by the cooling actuators, e.g., the supplied air temperature/flow rate of the cool air provided by the CRAC units, the cool water temperature/flow rate/pressure through the chillers, and the status of the cooling actuators such as the blower speed and the pump speed that again can be dynamically tuned during operation. An example cooling actuator power consumption model can be expressed as:

Pow_{c}=CoolingPower(CoolingStatus,ThermalStatus) EQN (4)

The example models of EQNs (1)-(4) can be derived from physical principles, equipment specifications, experimental data and/or tools such as a computational fluid dynamics (CFD) tool. The models of EQNs (1)-(4) can be used represent the steady-state relationship between the inputs, status, outputs, and/or transient relationships where the outputs may depend on historical inputs and/or outputs as defined by, for example, ordinary/partial differential/difference equations. Example mathematical expressions that may be used to implement and/or derive the example models of EQNs (1)-(4) are described in a paper by Wang et al. entitled “Optimal Fan Speed Control For Thermal Management of Servers,” which was published in the Proceedings of Interpack '09, Jul. 19-23, 2009.

As shown in FIG. 1, groups, zones and/or modules can be nested within other groups, zones and/or modules, and groups, zones and/or modules can be members of domains. In some examples, domains are not nested within other domains. Further, the example zones and/or modules 105 and 106 of FIG. 1 may contain groups, sub-zones and/or sub-modules that include the domains 115-117.

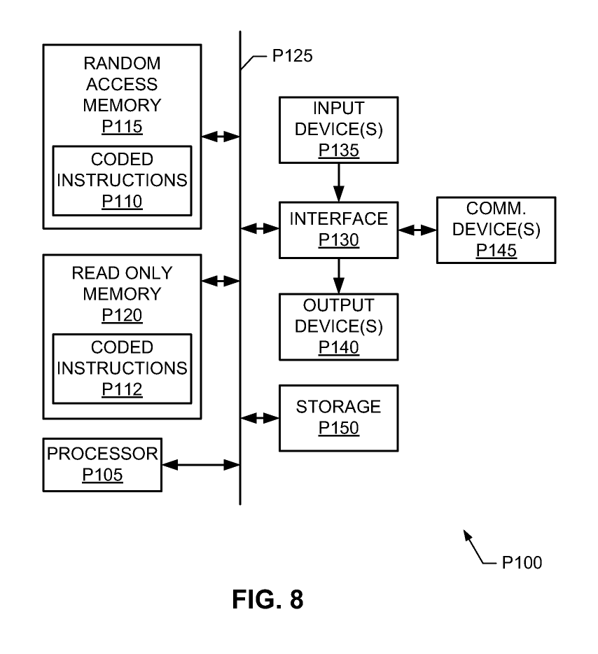

While an example layered power capping system has been illustrated in FIG. 1 one or more of the interfaces, data structures, elements, processes and/or devices illustrated in FIG. 1 may be combined, divided, re-arranged, omitted, eliminated and/or implemented in any other way. Further, the example GPCs 110, 120, 135, the example DPC 125 and/or the example LPC 145 may be implemented by hardware, machine-readable instructions (e.g., software, and/or firmware) and/or any combination of hardware, or machine-readable instructions (e.g., software and/or firmware). Thus, for example, any of the example GPCs 110, 120, 135, the example DPC 125 and/or the example LPC 145 may be implemented by the example process platform P100 of FIG. 8 and/or one or more circuit(s), programmable processor(s), fuses, application-specific integrated circuit(s) (ASIC(s)), programmable logic device(s) (PLD(s)), field-programmable logic device(s) (FPLD(s)), and/or field-programmable gate array(s) (FPGA(s)), etc. When any apparatus claim of this patent incorporating one or more of these elements is read to cover a purely software and/or firmware implementation, at least one of the example the example GPCs 110, 120, 135, the example DPC 125 and/or the example LPC 145 is hereby expressly defined to include a tangible article of manufacture such as a tangible computer-readable medium storing the machine-readable instructions (e.g., firmware and/or software).

FIG. 2 illustrates an example manner of implementing any of the example GPCs 110, 120 and/or 135 of FIG. 1. While any of the example GPCs 110, 120 and 135 may be represented by FIG. 2, for ease of discussion, the example GPC of FIG. 2 will be referred to as GPC 200. To measure power consumption, the example GPC 200 of FIG. 2 includes any number and/or type(s) of power consumption measurers 205. Using any number and/or type(s) of method(s), rule(s), logic and/or measurements taken by any number and/or type(s) of power consumption meters 210, the example power consumption measurer 205 of FIG. 2 measures the current power consumption of an associated portion of (or all of) a data center.

To estimate power consumption, the example GPC 200 of FIG. 2 includes a power consumption estimator 215. Using for example power consumption measurements taken by the example power consumption measurer 205, the example power consumption estimator 215 of FIG. 2 estimates the power consumption of an associated portion of (or all of) a data center for a future time interval. The example power consumption estimator 215 may, for example, use the example expressions of EQNs (1)-(4) to estimate power consumption.

To allocate power, the example GPC 200 of FIG. 2 includes a power allocator 220. The example power allocator 220 of FIG. 2 allocates its power consumption budget to its associated zones, modules and/or server groups based on their estimated, projected and/or measured demand, and the estimated, projected and/or measured power consumption of the cooling actuators of the zones, modules and/or server groups using any number and/or type(s) of method(s), algorithm(s) and/or logic such optimization, power consumption models and/or feedback control.

While an example manner of implementing the example GPCs 110, 120 and 135 of FIG. 1 has been illustrated in FIG. 2 one or more of the interfaces, data structures, elements, processes and/or devices illustrated in FIG. 2 may be combined, divided, re-arranged, omitted, eliminated and/or implemented in any other way. Further, the example power consumption measurer 205, the example power consumption estimator 215, the example power allocator 220 and/or, more generally, the example GPC 200 may be implemented by hardware, software, firmware and/or any combination of hardware, software and/or firmware. Thus, for example, any of the example power consumption measurer 205, the example power consumption estimator 215, the example power allocator 220 and/or, more generally, the example GPC 200 may be implemented by the example process platform P100 of FIG. 8 and/or one or more circuit(s), programmable processor(s), fuses, ASIC(s), PLD(s), FPLD(s), and/or FPGA(s), etc. When any apparatus claim of this patent incorporating one or more of these elements is read to cover a purely software and/or firmware implementation, at least one of the example power consumption measurer 205, the example power consumption estimator 215, the example power allocator 220 and/or, more generally, the example GPC 200 is hereby expressly defined to include a tangible article of manufacture such as a tangible computer-readable medium storing the machine-readable instructions (e.g., firmware and/or software).

FIG. 3 illustrates an example process that may be implemented using machine-accessible instructions, which may be carried out to implement the example GPCs 110, 120, 135 and/or 200 of FIGS. 1 and 2. The example machine-accessible instructions of FIG. 3 begin with the example power consumption measurer 205 (FIG. 2) measuring the power consumption of an associated portion of (or all of) a data center for a first or current time interval (block 305). The example power consumption estimator 215 estimates the power consumption of the portion of (or all of) the data center for a second or next time interval (block 310).

The example power allocator 220 allocates its power consumption budget to its associated zones, modules and/or server groups based on their estimated, projected and/or measured demand, and the estimated, projected and/or measured power consumption of the cooling actuators of the zones, modules and/or server groups (block 315). The example machine-accessible instructions of FIG. 3 delay a period of time (block 320) and then control returns to block 305.

FIG. 4 illustrates an example manner of implementing the example DPC 125 of FIG. 1. To measure power consumption, the example DPC 125 of FIG. 4 includes any number and/or type(s) of power consumption measurers 405. Using any number and/or type(s) of method(s), rule(s), logic and/or measurements taken by any number and/or type(s) of power consumption meters 410, the example power consumption measurer 405 of FIG. 4 measures the current power consumption of an associated server domain.

To estimate power consumption, the example DPC 125 of FIG. 4 includes a power consumption estimator 415. Using, for example, power consumption measurements taken by the example power consumption measurer 405, the example power consumption estimator 415 of FIG. 4 estimates the power consumption of the server domain. The example power consumption estimator 415 may, for example, use the example expressions of EQNs (1)-(4) to estimate power consumption.

To allocate applications, the example DPC 125 of FIG. 4 includes an application allocator 420. The example application allocator 420 of FIG. 4 allocates applications among its servers and/or server groups to comply with the power consumption allocated to its respective domain 117 by its GPC. The example application allocator 420 uses admission control, workload migration, workload consolidation and/or load balancing to comply with its allocated power consumption using any number and/or type(s) of method(s), algorithm(s) and/or logic such as optimization, power consumption models and/or feedback control. The example application allocator 420 may, additionally or alternatively, select to turn servers and/or server groups on and/or off. Example algorithms that may be used to assign applications to servers include, but are not limited to, simulated annealing and/or genetic hill climbing.

To move applications and/or workloads between servers, the example DPC 125 of FIG. 4 includes an application migrator 425. Using any number and/or type(s) of message(s), protocol(s) and/or method(s), the example application migrator 425 of FIG. 4 moves, balances, consolidates and/or migrates applications and/or workloads between servers. To turn servers on and off and/or put servers to sleep and/or into a low-power mode, the example DPC 125 of FIG. 4 includes a server disabler 430.

While an example manner of implementing the example DPC 125 of FIG. 1 has been illustrated in FIG. 4 one or more of the interfaces, data structures, elements, processes and/or devices illustrated in FIG. 4 may be combined, divided, re-arranged, omitted, eliminated and/or implemented in any other way. Further, the example power consumption measurer 405, the example power consumption estimator 415, the example application allocator 420, the example application migrator 425, the example server disabler 430 and/or, more generally, the example DPC 125 may be implemented by hardware, software, firmware and/or any combination of hardware, software and/or firmware. Thus, for example, any of the example power consumption measurer 405, the example power consumption estimator 415, the example application allocator 420, the example application migrator 425, the example server disabler 430 and/or, more generally, the example DPC 125 may be implemented by the example process platform P100 of FIG. 8 and/or one or more circuit(s), programmable processor(s), fuses, ASIC(s), PLD(s), FPLD(s), and/or FPGA(s), etc. When any apparatus claim of this patent incorporating one or more of these elements is read to cover a purely software and/or firmware implementation, at least one of the example power consumption measurer 405, the example power consumption estimator 415, the example application allocator 420, the example application migrator 425, the example server disabler 430 and/or, more generally, the example DPC 125 is hereby expressly defined to include a tangible article of manufacture such as a tangible computer-readable medium storing the machine-readable instructions (e.g., firmware and/or software).

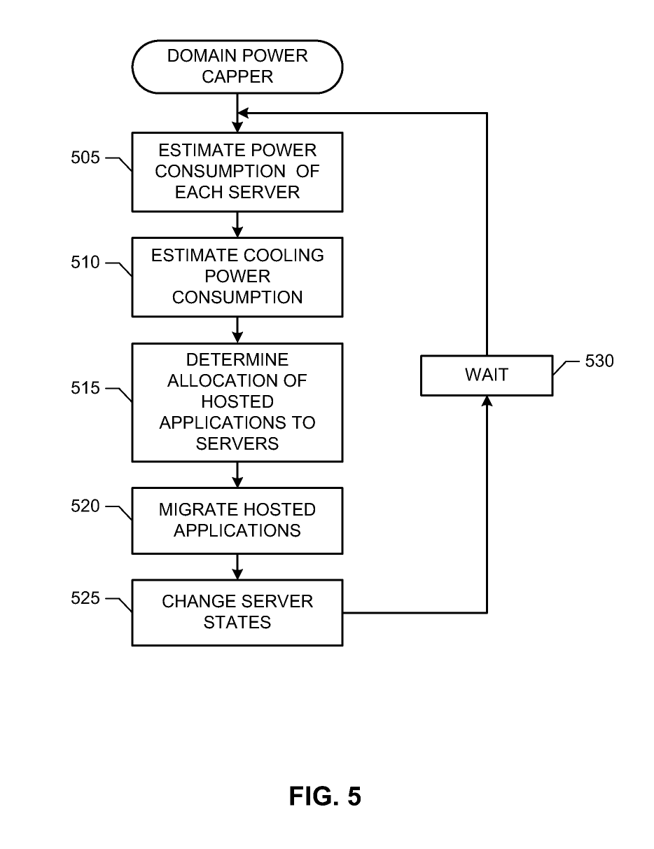

FIG. 5 illustrates an example process that may be implemented using machine-accessible instructions, which may be carried out to implement the example DPC 125 of FIGS. 1 and 4. The example machine-accessible instructions of FIG. 5 begin with the example power consumption estimator 415 estimating computing power consumption for each server (block 505) and cooling power consumption for the domain (block 510). Alternatively, at blocks 505 and 510, the power consumption measurer 405 measures computing power consumption and cooling power consumption, respectively.

The application allocator 420 determines an updated allocation of applications to servers based on the estimated and/or measured server and cooling power consumptions (block 515). For example, when the total power consumption (i.e., computing power consumption+cooling power consumption) does not comply with the power consumption allocated to the domain, the application allocator 420 moves and/or consolidates workloads and/or applications into fewer servers to reduce server power consumption. When the total power consumption complies with the power consumption allocated to the domain, the application allocator 420 may move and/or consolidate workloads and/or applications onto more servers to increase performance and/or onto fewer servers to further reduce server power consumption. The total power consumption complies with the allocated power consumption when, for example, the total power consumption is less than the allocated power consumption. The application migrator 425 migrates applications and/or workloads as determined by the application allocator 420 (block 520) and the server disabler 430 turns off any servers that are not to be used during the next time interval (block 525). The example machine-accessible instructions of FIG. 5 delay a period of time (block 530) and then control returns to block 505.

FIG. 6 illustrates an example manner of implementing the example LPC 145 of FIG. 1. To measure power consumption, the example LPC 145 of FIG. 6 includes any number and/or type(s) of power consumption measurers 605. Using any number and/or type(s) of method(s), rule(s), logic and/or measurements taken by any number and/or type(s) of power consumption meters 610, the example power consumption measurer 605 of FIG. 6 measures the current power consumption of an associated server domain.

To estimate power consumption, the example LPC 145 of FIG. 6 includes a power consumption estimator 615. Using, for example, power consumption measurements taken by the example power consumption measurer 605, the example power consumption estimator 615 of FIG. 6 estimates the power consumption of the server domain. The example power consumption estimator 615 may, for example, use the example expressions of EQNs (1)-(4) to estimate power consumption.

To select compute and cooling states, the example LPC 145 of FIG. 6 includes a state selector 620. The example state selector 620 of FIG. 6 uses, for example, feedback control such as a proportional integral derivative (PID) controller and/or a model predictive controller to select and/or control the state of its server (power status, supply voltage, clock frequency, etc.) and/or to select and/or control the state of cooling actuators (e.g., fans, etc.) associated with the server.

To set server states, the example LPC 145 of FIG. 6 includes any number and/or type(s) of server state controllers 625. To set cooling states, the example LPC 145 of FIG. 6 includes any number and/or type(s) of cooling state controllers 630.

While an example manner of implementing the example LPC 145 of FIG. 1 has been illustrated in FIG. 6 one or more of the interfaces, data structures, elements, processes and/or devices illustrated in FIG. 6 may be combined, divided, re-arranged, omitted, eliminated and/or implemented in any other way. Further, the example power consumption measurer 605, the example power consumption estimator 615, the example state selector 620, the example server state controller 615, the example cooling state controller 630 and/or, more generally, the example LPC 145 may be implemented by hardware, software, firmware and/or any combination of hardware, software and/or firmware. Thus, for example, any of the example power consumption measurer 605, the example power consumption estimator 615, the example state selector 620, the example server state controller 615, the example cooling state controller 630 and/or, more generally, the example LPC 145 may be implemented by the example process platform P100 of FIG. 8 and/or one or more circuit(s), programmable processor(s), fuses, ASIC(s), PLD(s), FPLD(s), and/or FPGA(s), etc. When any apparatus claim of this patent incorporating one or more of these elements is read to cover a purely software and/or firmware implementation, at least one of the example power consumption measurer 605, the example power consumption estimator 615, the example state selector 620, the example server state controller 615, the example cooling state controller 630 and/or, more generally, the example LPC 145 is hereby expressly defined to include a tangible article of manufacture such as a tangible computer-readable medium storing the machine-readable instructions (e.g., firmware and/or software).

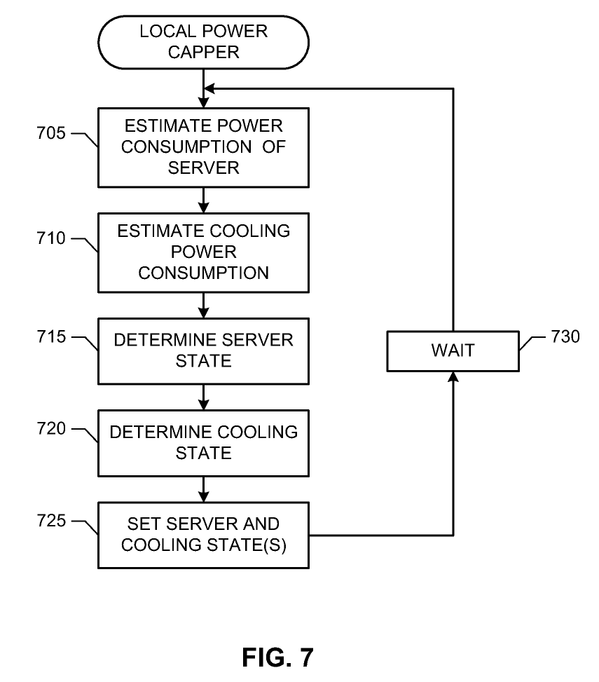

FIG. 7 illustrates an example process that may be implemented using machine-accessible instructions, which may be carried out to implement the example LPC 145 of FIGS. 1 and 6. The example machine-accessible instructions of FIG. 7 begin with the example power consumption estimator 615 estimating computing power consumption for its server (block 705) and cooling power consumption for the server (block 710). Alternatively, at blocks 705 and 710, the power consumption measurer 605 measures computing power consumption and cooling power consumption, respectively.

The state selector 620 selects and/or determines a server state (block 715) and a cooling state (block 720) based on the estimated and/or measured server and cooling power consumptions. The state selector 620 may change either of the states whether or not the total power consumption (i.e., computing power consumption+cooling power consumption) complies with the power consumption allocated to the domain. For example, even when the total power consumption complies with the power consumption allocated to the domain, the state selector 620 may change one or more of the states to, for example, increase performance and/or further decrease power consumption. The total power consumption complies with the allocated power consumption when, for example, the total power consumption is less than the allocated power consumption. The controllers 625 and 630 set the selected server state and the selected cooling state (block 725). The example machine-accessible instructions of FIG. 7 delay a period of time (block 730) and then control returns to block 705.

A processor, a controller and/or any other suitable processing device may be used, configured and/or programmed to execute and/or carry out the example machine-accessible instructions of FIGS. 3, 5 and/or 7. For example, the example machine-accessible instructions of FIGS. 3, 5 and/or 7 may be embodied in program code and/or instructions in the form of machine-readable instructions stored on a tangible computer-readable medium, and which can be accessed by a processor, a computer and/or other machine having a processor such as the example processor platform P100 of FIG. 8. Machine-readable instructions comprise, for example, instructions that cause a processor, a computer and/or a machine having a processor to perform one or more particular processes. Alternatively, some or all of the example machine-accessible instructions of FIGS. 3, 5 and/or 7 may be implemented using any combination(s) of fuses, ASIC(s), PLD(s), FPLD(s), FPGA(s), discrete logic, hardware, firmware, etc. Also, some or all of the example machine-accessible instructions of FIGS. 3, 5 and/or 7 may be implemented manually or as any combination of any of the foregoing techniques, for example, any combination of firmware, software, discrete logic and/or hardware. Further, many other methods of implementing the examples of FIGS. 3, 5 and/or 7 may be employed. For example, the order of execution may be changed, and/or one or more of the blocks and/or interactions described may be changed, eliminated, sub-divided, or combined. Additionally, any or all of the example machine-accessible instructions of FIGS. 3, 5 and/or 7 may be carried out sequentially and/or carried out in parallel by, for example, separate processing threads, processors, devices, discrete logic, circuits, etc.

As used herein, the term “tangible computer-readable medium” is expressly defined to include any type of computer-readable medium and to expressly exclude propagating signals. As used herein, the term “non-transitory computer-readable medium” is expressly defined to include any type of computer-readable medium and to exclude propagating signals. Example tangible and/or non-transitory computer-readable medium include a volatile and/or non-volatile memory, a volatile and/or non-volatile memory device, a compact disc (CD), a digital versatile disc (DVD), a floppy disk, a read-only memory (ROM), a random-access memory (RAM), a programmable ROM (PROM), an electronically-programmable ROM (EPROM), an electronically-erasable PROM (EEPROM), an optical storage disk, an optical storage device, magnetic storage disk, a magnetic storage device, a cache, and/or any other storage media in which information is stored for any duration (e.g., for extended time periods, permanently, brief instances, for temporarily buffering, and/or for caching of the information) and which can be accessed by a processor, a computer and/or other machine having a processor, such as the example processor platform P100 discussed below in connection with FIG. 8.

FIG. 8 is a block diagram of an example processor platform P100 capable of executing the example instructions of FIGS. 3, 5 and/or 7 to implement the example GPCs 110, 120, 135 and/or 200, the example DPC 125 and/or the example LPC 145. The example processor platform P100 can be, for example, a PC, a workstation, a laptop, a server and/or any other type of computing device containing a processor.

The processor platform P100 of the instant example includes at least one programmable processor P105. For example, the processor P105 can be implemented by one or more Intel® and/or AMD® microprocessors. Of course, other processors from other processor families and/or manufacturers are also appropriate. The processor P105 executes coded instructions P110 and/or P112 present in main memory of the processor P105 (e.g., within a volatile memory P115 and/or a non-volatile memory P120) and/or in a storage device P150. The processor P105 may execute, among other things, the example machine-accessible instructions of FIGS. 3, 5 and/or 7 to cap data center power consumption. Thus, the coded instructions P110, P112 may include the example instructions of FIGS. 3, 5 and/or 7.

The processor P105 is in communication with the main memory including the non-volatile memory P110 and the volatile memory P115, and the storage device P150 via a bus P125. The volatile memory P115 may be implemented by Synchronous Dynamic Random Access Memory (SDRAM), Dynamic Random Access Memory (DRAM), RAMBUS Dynamic Random Access Memory (RDRAM) and/or any other type of RAM device. The non-volatile memory P110 may be implemented by flash memory and/or any other desired type of memory device. Access to the memory P115 and the memory P120 may be controlled by a memory controller.

The processor platform P100 also includes an interface circuit P130. Any type of interface standard, such as an external memory interface, serial port, general-purpose input/output, as an Ethernet interface, a universal serial bus (USB), and/or a PCI express interface, etc, may implement the interface circuit P130.

The interface circuit P130 may also includes one or more communication device(s) 145 such as a network interface card to communicatively couple the processor platform P100 to, for example, others of the example GPCs 110, 120, 135 and/or 200, the example DPC 125 and/or the example LPC 145.

In some examples, the processor platform P100 also includes one or more mass storage devices P150 to store software and/or data. Examples of such storage devices P150 include a floppy disk drive, a hard disk drive, a solid-state hard disk drive, a CD drive, a DVD drive and/or any other solid-state, magnetic and/or optical storage device. The example storage devices P150 may be used to, for example, store the example coded instructions of FIGS. 3, 5 and/or 7.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent either literally or under the doctrine of equivalents.

What is claimed is:

1. A system comprising:
a group power capper to allocate a fraction of power for a data center to a portion of the data center;
a domain power capper to allocate hosted applications to a server of the portion of the data center to comply with the allocated portion of the power; and
a local power capper to control a first state of the server and a second state of a cooling actuator associated with the portion of the data center to comply with the allocated portion of the power.

2. The system as defined in claim 1, wherein the local power capper comprises:
a power consumption estimator to estimate a server power consumption and an associated cooling power consumption; and
a state selector to select the second state of the cooling actuator based on the estimated power consumptions and the allocated portion of the power.

3. The system as defined in claim 2, wherein the power consumption estimator implements at least one of a server power model or a server thermal model.

4. The system as defined in claim 1, wherein the local power capper comprises:
a power consumption measurer to measure a server power consumption and a cooling power consumption; and
a state selector to select the second state of the cooling actuator based on the measured power consumptions and the allocated portion of the power.

5. The system as defined in claim 1, wherein the group power capper comprises:
a power consumption estimator to estimate a server power consumption and an associated cooling power consumption for the portion of the data center; and
a power allocator to allocate the fraction of the power based on the estimated server and cooling power consumptions.

6. A method comprising:
configuring a state of a server to comply with a received allocated portion of a data center power consumption; and
configuring a state of a cooling actuator associated with the server to comply with the received allocated portion of the data center power consumption.

7. The method as defined in 6, further comprising:
estimating a power consumption of the server and the cooling actuator;
selecting the state of the server based on the estimated power consumption of the server; and
selecting the state of the cooling actuator based on the estimated power consumption of the server.

8. The method as defined in 7, wherein estimating the power consumption of the server comprises implementing a server power model.

9. The method as defined in 7, wherein estimating the power consumption of the cooling actuator comprises implementing a server thermal model.

10. The method as defined in 6, further comprising:
measuring a power consumption of the server and the cooling actuator;
selecting the state of the server based on the measured power consumption of the server; and
selecting the state of the cooling actuator based on the measured power consumption of the server.

11. A tangible article of manufacture storing machine-readable instructions that, when executed, cause a machine to at least:
configure a state of a server to comply with a received allocated portion of a data center power consumption; and
configure a state of a cooling actuator associated with the server to comply with the received allocated portion of the data center power consumption.

12. A tangible article of manufacture as defined in claim 11, wherein the machine-readable instructions, when executed, cause the machine to:
estimate a power consumption of the server and the cooling actuator;
select the state of the server based on the estimated power consumption of the server; and
select the state of the cooling actuator based on the estimated power consumption of the server.

13. A tangible article of manufacture as defined in claim 11, wherein the machine-readable instructions, when executed, cause the machine to estimate the power consumption of the server by at least implementing a server power model.

14. A tangible article of manufacture as defined in claim 11, wherein the machine-readable instructions, when executed, cause the machine to estimate the power consumption of the cooling actuator by at least implementing a server thermal model.

15. A tangible article of manufacture as defined in claim 11, wherein the machine-readable instructions, when executed, cause the machine to:
measure a power consumption of the server and the cooling actuator;
select the state of the server based on the measured power consumption of the server; and
select the state of the cooling actuator based on the measured power consumption of the server.
